(19) United States
(12) Patent Application Publication
(10) Pub. No.: US 2009/0297239 A1
(43) Pub. Date: Dec. 3, 2009

(54) CLEANING APPARATUS AND IMAGE FORMING APPARATUS

(75) Inventors: Azusa Aso, Tokyo (JP); Nobuhiko Okano, Tokyo (JP); Kiyoaki Kawamoto, Tokyo (JP); Tetsuya Ishikawa, Tokyo (JP); Hiroshi Isokawa, Tokyo (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/470,999

(22) Filed: May 22, 2009

(30) Foreign Application Priority Data
May 23, 2008 (JP) PATENT2008-134954

(51) Int. Cl. G03G 21/00

(52) U.S. Cl. 399/350; 399/353

(57) ABSTRACT

Disclosed a cleaning apparatus including: a brush to remove an adhered matter adhered to a photoconductor drum; wherein the brush includes: a first brush portion which contacts an end portion of the photoconductor drum in an axial direction, which portions is on a circumferential surface of the photoconductor drum, and in which portion a conductive base substance is exposed; and a second brush portion which contacts only a photosensitive layer on the circumferential surface of the photoconductor drum, and an electric resistance value of the first brush portion is larger than that of the second brush when a bias current is applied.

### BACKGROUND

1. Field of the Invention

The present invention relates to a cleaning apparatus and an image forming apparatus.

2. Description of Related Art

An image forming apparatus is equipped with a cleaning apparatus to remove an adhered matter (mainly toner) adhered to a photoreceptor.

Japanese Patent Application Laid-Open Publication No. Hei 9-138623 discloses a cleaning apparatus including a brush and a blade. It also discloses applying to the brush a bias having a same polar character as that of charge of a charging member to remove an electric charge with which the photoreceptor is charged so as to effectively remove the adhered matter.

However, by the cleaning apparatus of Japanese Patent Application Laid-Open Publication No. Hei 9-138623, since a blush width is shorter than a photoreceptor width, a toner which has been removed by the blade and are dropping can not be collected in a region where the brush does not exist (contact). Thus, the toner sometimes spills out or flies apart.

Moreover, if the brush width is equal to or longer than the photoreceptor width in the cleaning apparatus of Japanese Patent Application Laid-Open Publication No. Hei 9-138623, a bias current applied to the brush leaks through a base substance of the photoreceptor. For this reason, a cleaning performance can not be ensured. Incidentally, the photoreceptor is configured to have a photosensitive layer formed on a conductive base substance, and depending on a method (dip coating step or the like) for manufacturing the photoreceptor, the base substance is exposed on at least one end portion of the photoreceptor.

### SUMMARY

An object of the present invention is to prevent a leak of a bias current applied to a brush to improve a cleaning performance, as well as to prevent a toner from dropping or flying apart.

In order to achieve the above-described object, according to a first aspect of the present invention, there is provided a cleaning apparatus including: a brush to remove an adhered matter adhered to a photoconductor drum; wherein the brush includes: a first brush portion which contacts an end portion of the photoconductor drum in an axial direction, which portions is on a circumferential surface of the photoconductor drum, and in which portion a conductive base substance is exposed; and a second brush portion which contacts only a photosensitive layer on the circumferential surface of the photoconductor drum, and an electric resistance value of the first brush portion is larger than that of the second brush when a bias current is applied.

Moreover, in order to achieve the above-described object, according to a second aspect of the present invention, there is provided an image forming apparatus including: a photoconductor drum; and a cleaning apparatus to remove an adhered matter adhered to the photoconductor drum with a brush, wherein the photoconductor drum includes a photosensitive layer on a conductive base substance, and the base substance is exposed in at least one end portion of the photoconductor drum in an axial direction among both end portions of the photoconductor drum, which portions are on a circumferential surface of the photoconductor drum, the brush includes a first brush portion which contacts the end portion in the axial direction where the base substance is exposed and a second brush portion which contacts only the photosensitive layer on the circumferential surface of the photoconductor drum, and an electric resistance value of the first brush portion is larger than that of the second brush when a bias current is applied.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a whole configuration diagram of an image forming apparatus;

FIG. 2 is a whole configuration diagram of a cleaning apparatus;

FIG. 3 is a diagram showing a correlation among a photoreceptor width, a brush width and a blade width;

FIG. 4 is a diagram for explaining a method for measuring an electric resistance value;

FIG. 5A is a diagram showing an experimental result; and

FIG. 5B is a diagram showing an experimental result.

### DETAILED DESCRIPTION OF THE PREFERRED EMBODIMENT

The most suitable configuration and operation of a cleaning apparatus and an image forming apparatus according to the embodiment will be explained in detail with reference to drawings below.

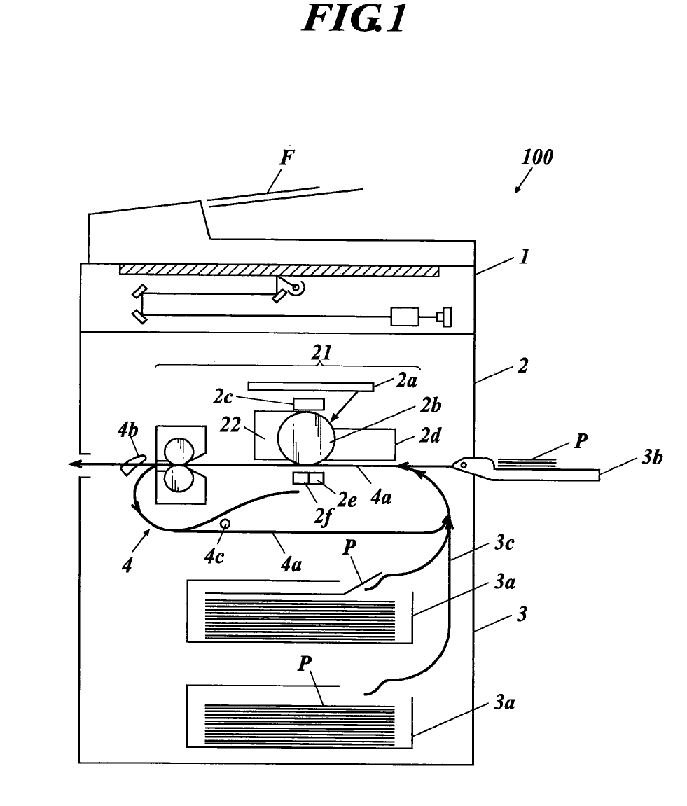

FIG. 1 shows a schematic cross-section diagram of an image forming apparatus 100.

The image forming apparatus 100 is configured to include a reading section 1, an image forming section 2, a feeding section 3, a conveying section 4, and so on.

The reading section 1 is equipped with an optical system including a contact glass, a platen glass, a light source, a mirror, a collective lens, a CCD and the like.

The reading section 1 converts an image on an original document F placed on a reading tray with the optical system into an electric signal to output the converted electric signal to the image forming section 2.

The image forming section 2 is configured to include an image forming processing section 21, a cleaning apparatus 22 and the like.

The image forming processing section 21 is equipped with a laser unit 2a, a photoreceptor 2b, a charging device 2c, a developing device 2d, a transferring device 2e, a separating device 2f and the like. Incidentally, the photoreceptor 2b herein described is capable of being applied to a photoconductor drum having a drum-like shape. The image forming processing section 21 transfers a toner image on a sheet P by using these devices.

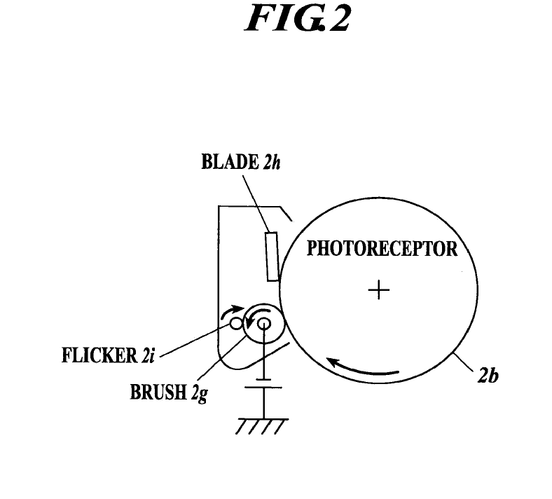

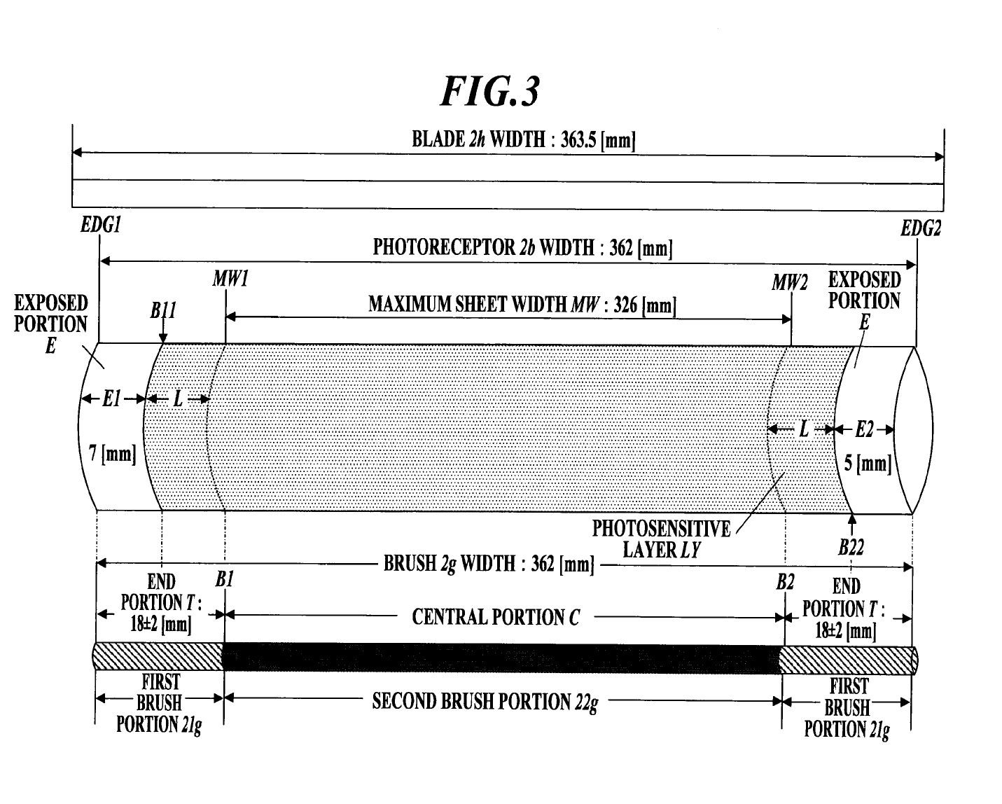

The cleaning apparatus 22 removes a toner, a paper powder or the like (hereinafter referred to as “an adhered matter”) adhered to the photoreceptor 2b after the toner image has been transferred from the photoreceptor 2b onto the sheet P. The cleaning apparatus 22 will hereinafter be described in detail with reference to FIGS. 2 and 3.

The feeding section 3 is configured to include a feeding tray 3a, a manual feeding tray 3b, a feeding roller 3c and the like. The feeding tray 3a and the manual feeding tray 3b house a plurality of sheets P, and the feeding roller 3c feeds the sheet P to the image forming section 2 through the conveying section 4.

The conveying section 4 is configured to include a conveying path 4a, a switching claw 4b, a reversing roller 4c and the like. The conveying path 4a conveys the sheet P to the image forming processing section 21 with operations of the switching claw 4b and the reversing roller 4c to convey the sheet P outward.

FIG. 2 shows a schematic cross-section diagram of the cleaning apparatus 22 and the photoreceptor 2b.

The cleaning apparatus 22 is configured to include a brush 2g, a blade 2h, a flicker 2i and the like.

The brush 2g has brush bristles around a brush shaft, and rotates while the brush bristles contact a surface of the photoreceptor 2b. Moreover, a bias current is applied to the brush 2g. The brush 2g to which the bias current is applied draws electrostatically the adhered matter adhered to the photoreceptor 2b, and thereby a removing ability of the brush 2g is improved.

The flicker 2i removes the adhered matter adhered to the brush 2g.

The blade 2h is provided on a down-stream side of the brush 2g in a rotation direction of the photoreceptor 2b, and further removes the adhered matter remaining in the photoreceptor 2b.

FIG. 3 shows a correlation among a width of the photoreceptor 2b, a width of the brush 2g and a width of the blade 2h.

In the embodiment, the width of the photoreceptor 2b, the width of the brush 2g and the width of the blade 2h comply with a correlation shown in (1-1) or (1-2) given below.

(1-1) width of photoreceptor 2b≦width of brush 2g, and width of photoreceptor 2b<width of the blade 2h

(1-2) width of photoreceptor 2b<width of brush 2g, width of the blade 2h

Incidentally, the “width” herein described means a length of each of the photoreceptor 2b, the brush 2g and the blade 2h in an axial direction thereof. Moreover, numeric values of the width (362 [mm]) of the photoreceptor 2b, the width (362 [mm]) of the brush 2g, and the width (363.5 [mm]) of the blade 2h shown in FIG. 3 are illustrative only, and are not limited to these specific values as long as they comply with the correlation shown in above-described (1-1) or (1-2).

When the brush 2g is used as a brush, an electric resistance value [Ω] in end portions T of the brush 2g is different from that in a central portion C of the brush 2g. First brush portions 21g are used in the end portions T, and a second brush portion 22g is used in the central portion C. Incidentally, an original yarn resistance value of the brush bristle is represented by the unit of [Ω·cm] when the brush 2g is not used as a brush, but the unit is not considered here.

Here, “the end portions T” of the brush 2g are portions which contact exposed portions E of the photoreceptor 2b where a base substance thereof is exposed, and contact parts L of a photosensitive layer LY of the photoreceptor 2b. Moreover, “the parts L of the photosensitive layer LY” are portions including parts of the photosensitive layer LY which is 1 (one) [mm] or more from borders B11, B22 between the exposed portions E and the photosensitive layer LY, and not including a maximum sheet width MW of the photosensitive layer LY. In other words, borders B1, B2 between the first brush portions 21g and the second brush portion 22g are situated nearer a center of the photoreceptor 2b in relation to the borders B11, B22, namely nearer an edge portion EDG2 in the case of the border B1, and nearer an edge portion EDG1 in the case of the border B2. Moreover, the borders B1, B2 are situated at positions corresponding to end portions MW1, MW2 of the maximum sheet width MW, or situated nearer edge portions of the photoreceptor 2b in relation to the end portions MW1, MW2, namely nearer the edge portion EDG1 in the case of the border B1, and nearer an edge portion EDG2 in the case of the border B2.

Furthermore, “the central position C” of the brush 2g is a portion except the end portions T.

Incidentally, numeric values of a sheet width (326 [mm]), widths (E1 is 7 [mm] or less, and E2 is 5 [mm] or less) of the exposed portions E, the end portions T (18±2 [mm]) are illustrative only, and not limited to these specific values as long as they comply with the above correlation.

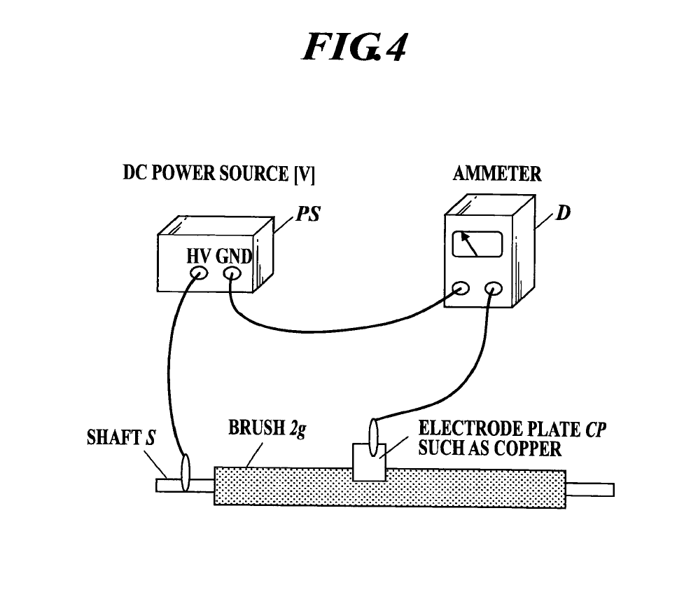

A method for measuring an electric resistance value [Ω] of the brush 2g will be explained with reference to FIG. 4.

It is assumed that the brush 2g to be subjected to measuring is kept in an environment where a room temperature is 25° C. and humidity is 50% RH. In addition, it is assumed that a direct-current power source apparatus PS, the brush 2g and an ammeter D are connected to one another as shown in FIG. 4.

Firstly, an electrode plate CP is allowed to bite into the brush 2g fixed at a base by 1 (one) [mm]. Next, a direct voltage is applied from the direct-current power source apparatus PS to a shaft portion S of the brush 2g. Incidentally, the shaft portion S is composed of conductive material (metal shaft and the like).

Then, the ammeter D reads a current value [A] at 10 minutes after the direct voltage [V] is applied.

The electric resistance [Ω] of the brush 2g is measured by substituting the direct voltage [V] and the current value [A] in the formula such that the electric resistance [Ω] of the brush 2g=the applied direct voltage [V]/the read current value [A].

The electric resistance [Ω] of the first brush portion 21g measured by the measuring method shown in FIG. 4 is larger than that of the second brush portion 22g. Thus, a leak at the base substance exposed portion E can be prevented and a cleaning performance can be ensured.

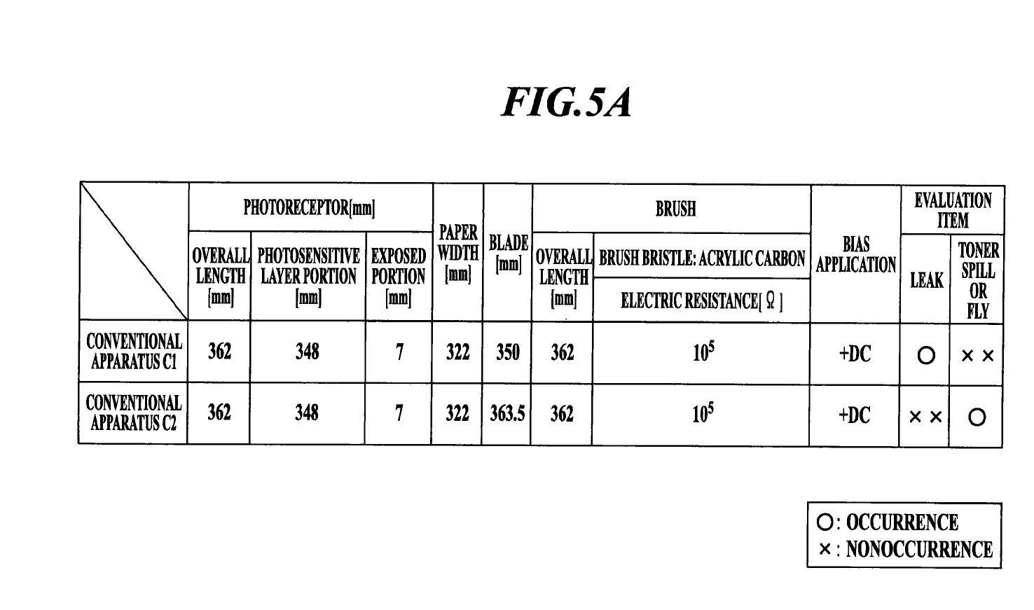

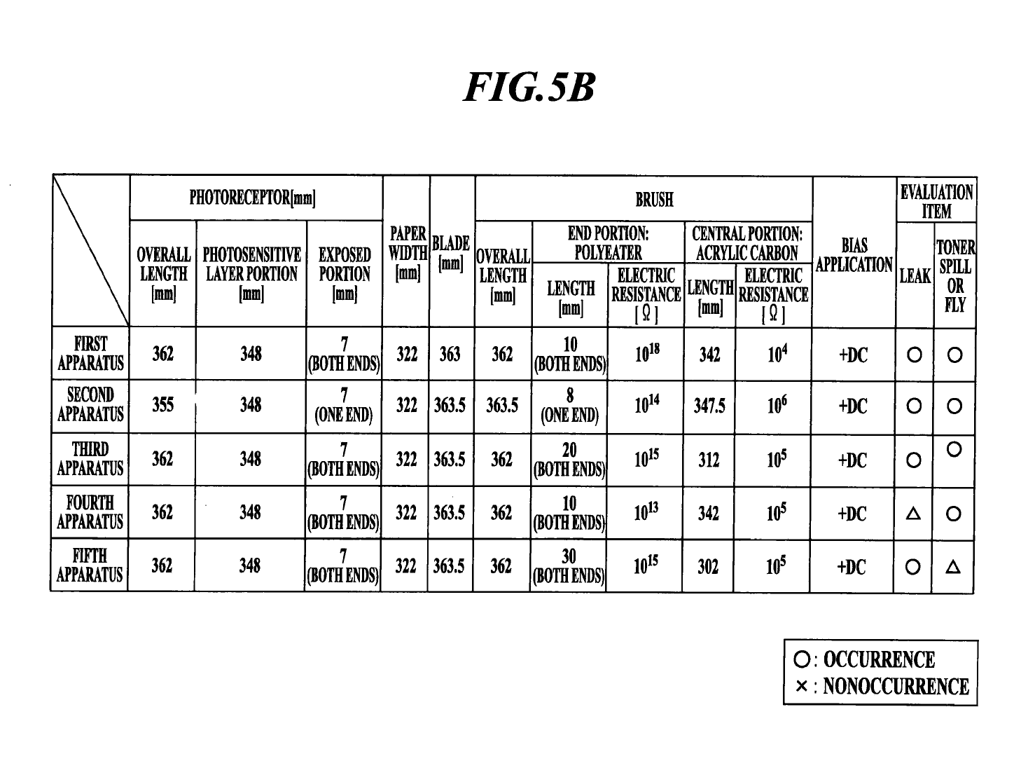

FIGS. 5A and 5B shows examples of experimental results.

Experiments shown in FIGS. 5A and 5B are performed by changing each component constituting the cleaning apparatus, specifically each of components of (1) the electric resistance of the brush, (2) the photo receptor width, (3) the brush width, and (4) the blade width of the examples of the examples.

In addition, the experimental results in FIGS. 5A and 5B show evaluation items regarding whether or not the bias current applied to the shaft portion S of the brush leaks and whether or not the toner spills or flies on the sheet on which the image has been formed. Incidentally, the judgment whether or not the toner spills or flies on the sheet is performed based on whether or not one or plurality of toner pollutions occur on the sheet.

### COMPARISON EXAMPLE

Firstly, experimental results in the cases of using conventional cleaning apparatuses will be explained with reference to FIG. 5A.

A conventional apparatus C1 in FIG. 5A is a cleaning apparatus where the electric resistance of the brush is constant throughout a range (the end portion and the central portion) of the brush, and the brush width and the blade width are shorter than the photoreceptor width. Specifically, the conventional apparatus C1 is configured so that the electric resistance of the brush is 10̂5 [Ω] without exception, the photoreceptor width is 362 [mm], the brush width is 350 [mm], and the blade width is 350 [mm].

By the conventional apparatus C1, a leak did not occur, but a toner spill or fly occurred.

A conventional apparatus C2 in FIG. 5A is a cleaning apparatus where the electric resistance of the brush is constant throughout a range of the brush, and the photoreceptor width and the brush width are same and the blade width is longer than the photoreceptor width. Specifically, the conventional apparatus C2 is configured so that the electric resistance of the brush is 10̂5 [Ω] without exception, the photoreceptor width and the brush width is 362 [mm], and the blade width is 363.5 [mm].

By the conventional apparatus C2, a toner spill or fly occur did not occur, but a leak occurred.

### EXAMPLES

Next, experimental results in the cases of using the cleaning apparatus 22 of the embodiment will be explained with reference to FIG. 5B. Incidentally, as described above, any of the cleaning apparatus 22 of the embodiment is a cleaning apparatus where the electric resistances of the brush are different between the end portion T and the central portion C, and the width of the photoreceptor 2b, the width of the brush 2g and the width of the blade 2h have a relation of above-described (1-1) or (1-2). In addition, the experimental results of FIG. 5B show the case where the image is continuously formed by using 300 thousand pieces of A4 paper.

In a first apparatus in FIG. 5B, an electric resistance in the end portions T of the brush is 10̂8 [Ω], and an electric resistance in the central portion C of the brush is 10̂4 [Ω]. Moreover, the first apparatus is configured so that the width of the photoreceptor 2b is 362 [mm], both of the base substance exposed portions E are 7 [mm], the width of the brush 2g is 362 [mm], both of the end portions T of the brush are 10 [mm], and the width of the blade 2h is 363 [mm].

According to the first apparatus, a leak and a toner spill or fly did not occur.

In a second apparatus in FIG. 5B, an electric resistance in the end portion T of the brush is 10̂14 [Ω], an electric resistance in the central portion C of the brush is 10̂6 [Ω]. Moreover, the second apparatus is configured so that the width of the photoreceptor 2b is 355 [mm], the base substance exposed portion E on one side (the other side is the photosensitive layer) is 7 [mm], the width of the brush 2g is 363.5 [mm], the end portion T of the brush on one side is 8 [mm], and the width of the blade 2h is 363.5 [mm].

According to the second apparatus, a leak and a toner spill or fly did not occur.

In a third apparatus in FIG. 5B, an electric resistance in the end portions T of the brush is 10̂15 [Ω], and an electric resistance in the central portion C of the brush is 10̂5 [Ω]. Moreover, the third apparatus is configured so that the width of the photoreceptor 2b is 362 [mm], both of the base substance exposed portions E are 7 [mm], the width of the brush 2g is 362 [mm], both of the end portions T of the brush are 20 [mm], and the width of the blade 2h is 363.5 [mm].

According to the third apparatus, a leak and a toner spill or fly did not occur.

In a fourth apparatus in FIG. 5B, an electric resistance in both of the end portions T of the brush is 10̂13 [Ω], and an electric resistance in the central portion C of the brush is 10̂5 [Ω]. Moreover, the fourth apparatus is configured so that the width of the photoreceptor 2b is 362 [mm], both of the base substance exposed portions E are 7 [mm], the width of the brush 2g is 362 [mm], both of the end portions T of the brush are 10 [mm], and the width of the blade 2h is 363.5 [mm].

According to the fourth apparatus, though a leak partially occurred, a toner spill or fly did not occur.

In a fifth apparatus in FIG. 5B, an electric resistance in both of the end portions T of the brush is 10̂15 [Ω], and an electric resistance in the central portion C of the brush is 10̂[Ω]. Moreover, the fifth apparatus is configured so that the width of the photoreceptor 2b is 362 [mm], both of the base substance exposed portions E are 7 [mm], the width of the brush 2g is 362 [mm], both of the end portions T of the brush are 30 [mm], and the width of the blade 2h is 363.5 [mm].

According to the fifth apparatus, though a toner spill or fly partially occurred, a leak did not occur.

According to a first aspect of the present invention, there is provided a cleaning apparatus including: a brush to remove an adhered matter adhered to a photoconductor drum; wherein the brush includes: a first brush portion which contacts an end portion of the photoconductor drum in an axial direction, which portions is on a circumferential surface of the photoconductor drum, and in which portion a conductive base substance is exposed; and a second brush portion which contacts only a photosensitive layer on the circumferential surface of the photoconductor drum, and an electric resistance value of the first brush portion is larger than that of the second brush when a bias current is applied.

According to this configuration, it becomes possible to prevent the bias current from leaking from the first brush portion at the end portion to the base substance exposed portion of the photoreceptor, and thereby the cleaning performance can be ensured.

Preferably, the first brush portion uses an insulating brush bristle.

According to this configuration, a leak can be effectively prevented.

Preferably, the electric resistance value of the first brush portion when the first brush portion is used as a brush is 10̂14 [Ω] or more.

According to this configuration, a leak can be effectively prevented and the cleaning performance can be ensured.

Preferably, a length of the brush in an axial direction is equal to a length of the photoconductor drum in the axial direction or longer than the length of the photoconductor drum in the axial direction.

According to this configuration, the adhered matter adhered to the photoreceptor can be properly removed throughout the range of the photoreceptor, and at the same time, the toner spill or fly can be prevented.

Preferably, a border between the first brush portion and the second brush portion is situated 1 [mm] or more nearer a center of the photoconductor drum in the axial direction in relation to a border between the base substance and the photosensitive layer, and situated at a portion corresponding to an end portion of a maximum sheet width or nearer an edge portion of the photoconductor drum in the axial direction in relation to the end portion of the maximum sheet width.

According to this configuration, the leak can be surely prevented, and it becomes possible to prevent a problem (for example, an occurrence of a difference in image density and the like) due to a potential difference (potential difference between the portion where the first brush portion contacts and the portion where the second brush portion contacts) on the photoreceptor from occurring on the image formed on the sheet.

Preferably, the cleaning apparatus further includes: a blade to further remove the adhered matter, wherein the blade is provided on a down-stream side of the brush in a rotation direction of the photoconductor drum.

According to this configuration, the cleaning performance can be further improved.

Preferably, the cleaning apparatus further includes: a blade to further remove the adhered matter, wherein a length of the blade in an axial direction is longer than a length of the photoconductor drum in the axial direction.

According to this configuration, the adhered matter adhered to the photoreceptor can be removed throughout the photoreceptor, and at the same time, a toner fly can be prevented.

According to a second aspect of the present invention, there is provided an image forming apparatus including: a photoconductor drum; and a cleaning apparatus to remove an adhered matter adhered to the photoconductor drum with a brush, wherein the photoconductor drum includes a photosensitive layer on a conductive base substance, and the base substance is exposed in at least one end portion of the photoconductor drum in an axial direction among both end portions of the photoconductor drum, which portions are on a circumferential surface of the photoconductor drum, the brush includes a first brush portion which contacts the end portion in the axial direction where the base substance is exposed and a second brush portion which contacts only the photosensitive layer on the circumferential surface of the photoconductor drum, and an electric resistance value of the first brush portion is larger than that of the second brush when a bias current is applied.

Preferably, the first brush portion uses an insulating brush bristle.

According to this method, a leak can be effectively prevented.

Preferably, the electric resistance value of the first brush portion when the first brush portion is used as a brush is 10̂14 [Ω] or more.

According to this method, a leak can be effectively prevented and the cleaning performance can be ensured.

Preferably, a length of the brush in an axial direction is equal to a length of the photoconductor drum in the axial direction or longer than the length of the photoconductor drum in the axial direction.

According to this method, the adhered matter adhered to the photoreceptor can be properly removed throughout the range of the photoreceptor, and at the same time, the toner spill or fly can be prevented.

Preferably, a border between the first brush portion and the second brush portion is situated 1 [mm] or more nearer a center of the photoconductor drum in the axial direction in relation to a border between the base substance and the photosensitive layer, and situated at a portion corresponding to an end portion of a maximum sheet width or nearer an edge portion of the photoconductor drum in the axial direction in relation to the end portion of the maximum sheet width.

According to this method, the leak can be surely prevented, and it becomes possible to prevent a problem (for example, an occurrence of a difference in image density and the like) due to a potential difference (potential difference between the portion where the first brush portion contacts and the portion where the second brush portion contacts) on the photoreceptor from occurring on the image formed on the sheet.

Preferably, the image forming apparatus further includes: a blade to further remove the adhered matter, wherein the blade is provided on a down-stream side of the brush in a rotation direction of the photoconductor drum.

According to this method, the cleaning performance can be further improved.

Preferably, the image forming apparatus further includes: a blade to further remove the adhered matter, wherein a length of the blade in an axial direction is longer than a length of the photoconductor drum in the axial direction.

According to this method, the adhered matter adhered to the photoreceptor can be removed throughout the photoreceptor, and at the same time, a toner fly can be prevented.

The present U.S. patent application claims a priority under the Paris Convention of Japanese patent application No. 2008-134954 filed on May 23, 2008, which shall be a basis of correction of an incorrect translation.

What is claimed is:

1. A cleaning apparatus comprising:
a brush to remove an adhered matter adhered to a photoconductor drum; wherein
the brush includes:
a first brush portion which contacts an end portion of the photoconductor drum in an axial direction, which portions is on a circumferential surface of the photoconductor drum, and in which portion a conductive base substance is exposed; and
a second brush portion which contacts only a photosensitive layer on the circumferential surface of the photoconductor drum, and
an electric resistance value of the first brush portion is larger than that of the second brush when a bias current is applied.

2. The cleaning apparatus of claim 1 wherein the first brush portion uses an insulating brush bristle.

3. The cleaning apparatus of claim 1 wherein the electric resistance value of the first brush portion when the first brush portion is used as a brush is 10̂14 [Ω] or more.

4. The cleaning apparatus of claim 1 wherein a length of the brush in an axial direction is equal to a length of the photoconductor drum in the axial direction or longer than the length of the photoconductor drum in the axial direction.

5. The cleaning apparatus of claim 1 wherein a border between the first brush portion and the second brush portion is situated 1 [mm] or more nearer a center of the photoconductor drum in the axial direction in relation to a border between the base substance and the photosensitive layer, and situated at a portion corresponding to an end portion of a maximum sheet width or nearer an edge portion of the photoconductor drum in the axial direction in relation to the end portion of the maximum sheet width.

6. The cleaning apparatus of claim 1 further comprising:
a blade to further remove the adhered matter, wherein
the blade is provided on a down-stream side of the brush in a rotation direction of the photoconductor drum.

7. The cleaning apparatus of claim 1 further comprising:
a blade to further remove the adhered matter, wherein
a length of the blade in an axial direction is longer than a length of the photoconductor drum in the axial direction.

8. An image forming apparatus comprising:
a photoconductor drum; and
a cleaning apparatus to remove an adhered matter adhered to the photoconductor drum with a brush, wherein
the photoconductor drum includes a photosensitive layer on a conductive base substance, and the base substance is exposed in at least one end portion of the photoconductor drum in an axial direction among both end portions of the photoconductor drum, which portions are on a circumferential surface of the photoconductor drum,
the brush includes a first brush portion which contacts the end portion in the axial direction where the base substance is exposed and a second brush portion which contacts only the photosensitive layer on the circumferential surface of the photoconductor drum, and
an electric resistance value of the first brush portion is larger than that of the second brush when a bias current is applied.

9. The image forming apparatus of claim 8 wherein the first brush portion uses an insulating brush bristle.

10. The image forming apparatus of claim 8 wherein the electric resistance value of the first brush portion when the first brush portion is used as a brush is 10̂14 [Ω] or more.

11. The image forming apparatus of claim 8 wherein a length of the brush in an axial direction is equal to a length of the photoconductor drum in the axial direction or longer than the length of the photoconductor drum in the axial direction.

12. The image forming apparatus of claim 8 wherein a border between the first brush portion and the second brush portion is situated 1 [mm] or more nearer a center of the photoconductor drum in the axial direction in relation to a border between the base substance and the photosensitive layer, and situated at a portion corresponding to an end portion of a maximum sheet width or nearer an edge portion of the photoconductor drum in the axial direction in relation to the end portion of the maximum sheet width.

13. The image forming apparatus of claim 8 further comprising:
a blade to further remove the adhered matter, wherein
the blade is provided on a down-stream side of the brush in a rotation direction of the photoconductor drum.

14. The image forming apparatus of claim 8 further comprising:
a blade to further remove the adhered matter, wherein
a length of the blade in an axial direction is longer than a length of the photoconductor drum in the axial direction.
